(19) United States
(12) Patent Application Publication
(10) Pub. No.: US 2009/0072584 A1
(43) Pub. Date: Mar. 19, 2009

(54) Portable power systems, methods, and apparatus

(76) Inventor: Ron Tisdal, Winterhaven, FL (US)

Correspondence Address: MY LAW DADDY, LLC, 1521 ALTON ROAD, SUITE 228, MIAMI BEACH, FL, 33139, US

(21) Appl. No.: 12/232,501

(22) Filed: Sep. 18, 2008

Related U.S. Application Data
(60) Provisional application No. 60/994,044, filed on Sep. 18, 2007.

(51) Int. Cl. B60P 3/34; B60P 3/355; F16H 57/02; F16H 21/12

(52) U.S. Cl. 296/173; 74/63; 74/606 R

(57) ABSTRACT

Systems and apparatus for reducing rotational speed, including: an enclosed gear box; a gear speed reduction drive including a first gear and a second gear that is circumferentially smaller than the first gear and that either (a) directly drives the first gear in a direction opposite to a direction of the second gear, or (b) indirectly drives the first gear in the same direction as the direction of the second gear; the gear speed reduction drive being disposed within the enclosed gear box; an input shaft extending from the second gear, the drive shaft driving the gear speed reduction drive; an output shaft driven by the first gear and having an adapter end, the rotational speed of the output shaft being slower than the rotational speed; and methods utilizing the systems and methods.

### CROSS-REFERENCE TO RELATED APPLICATIONS

This application claims priority to U.S. provisional patent application No. 60/994,044 filed Sep. 18, 2007, the subject matter of which is hereby incorporated herein by reference in its entirety.

### STATEMENT REGARDING FEDERALLY SPONSORED RESEARCH OR DEVELOPMENT

(Not Applicable)

### THE NAMES OF THE PARTY TO A JOINT RESEARCH AGREEMENT

(Not Applicable)

### INCORPORATION-BY-REFERENCE OF MATERIAL SUBMITTED ON A COMPACT DISC

(Not Applicable)

### BACKGROUND OF THE INVENTION

(1) Field of the Invention

This disclosure is directed to methods, systems, and apparatus that provide effective ways in which to lower and raise objects. This disclosure is also directed to methods, systems, and apparatus for raising and lowering pop-up campers.

(2) Description of Related Art Including Information Submitted Under 37 CFR 1.97 and 1.98

Pop-up campers are typically raised and lowered via a manual system, in particular a manual winch. However, raising and lowering pop-up campers with such manual systems can be difficult, especially for the elderly and children. Due to this difficulty, many people can be unable or forced to stop camping at least in such campers. While there are lift systems on the market, such systems do not offer the design, convenience and advantages of the systems, methods, and apparatus disclosed herein.

U.S. Pat. No. 5,865,499 to Keyser, the subject matter of which is hereby incorporated by reference in its entirety, discloses that a “camper crank drive mechanism provides for the powered operation of the top erecting and retracting mechanism of a camper vehicle having a folding top. The [Keyser] mechanism secures to the camper structure, and has an output shaft which engages the conventional crank input of the camper vehicle. The [Keyser] crank drive mechanism comprises a gear speed reduction unit, which reduces the input speed and multiplies the input torque considerably, in order to allow a relatively small and lightweight battery operated power tool (cordless electric drill, power screwdriver, etc.) to be utilized to operate the reduction mechanism . . . [and the] power tool utilized to operate the [Keyser] gear mechanism may be powered by its own internal battery, or may alternatively be powered by a larger external battery, if desired, which external battery may be recharged from the towing vehicle charging system.” See the abstract of Keyser.

One electric lift system currently on the market, similar to the Keyser system described above, suffers numerous disadvantages. First, it is difficult to install, in particular because it requires the user to remove the manual system. Second, once installed, the manual system is no longer available for use. Thus, if the battery goes dead on the electric lift system, there is no way for the user to raise or lower their pop-up camper. Third, the electric lift system is expensive.

### BRIEF SUMMARY OF THE INVENTION

At least some aspects and embodiments of this disclosure are directed to an apparatus for reducing rotational speed, including: an enclosed gear box; a gear speed reduction drive including a first gear and a second gear that is circumferentially smaller than the first gear and that either (a) directly drives the first gear in a direction opposite to a direction of the second gear, or (b) indirectly drives the first gear in the same direction as the direction of the second gear; the gear speed reduction drive being disposed within the enclosed gear box; the drive shaft driving the gear speed reduction drive; an output shaft driven by the first gear and having an adapter end, the rotational speed of the output shaft being slower than the rotational speed.

In at least some embodiments, the apparatus can further include a connector having an end configured to engage with the adapter end and an opposite end configured to connect to a pop-up camper for raising and lowering the pop-up camper. In at least some embodiments, the apparatus can further include a connector having an end configured to engage with the adapter end and an opposite end configured to connect to a vehicle jack for raising and lowering a vehicle in order to change a vehicle tire. In at least some embodiments, the apparatus can further include a first removable connector having an end configured to engage with the adapter end and an opposite end configured to connect to a vehicle jack for raising and lowering a vehicle in order to change a vehicle tire and a second removable connector having an end configured to engage with the adapter end and an opposite end configured to connect to a pop-up camper for raising and lowering the pop-up camper. In at least some embodiments, the apparatus can further include a first removable connector having an end configured to engage with the adapter end and an opposite end configured to a first brand of pop-up camper having a particular connecting mechanism for raising and lowering the pop-up camper and a second removable connector having an end configured to engage with the adapter end and an opposite end configured to connect to a second brand of pop-up camper having a different connecting mechanism from the first brand for raising and lowering the pop-up camper.

In at least some embodiments, the circumferential ratio of the second gear to the first gear ranges from a ratio of 2 to 1 to a ratio of 20 to 1. In at least some embodiments, the circumferential ratio is 5.45 to 1. In at least some embodiments, the second gear is a 60 tooth sprocket and the first gear is an 11 tooth sprocket. In at least some embodiments, the apparatus can further include a chain between the first and second gears, and wherein the second gear indirectly drives the first gear through movement of the chain. In at least some embodiments, the chain is a number 35 chain.

In at least some embodiments, the apparatus can further include a belt between the first and second gears, and wherein the second gear indirectly drives the first gear through movement of the belt. In at least some embodiments, the second gear directly contacts and drives the first gear. In at least some embodiments, the apparatus can further include a motor and a rechargeable battery contained with the housing to provide power to turn the input shaft. In at least some embodiments, the input shaft can be turned by a rotary power tool that is separate from the apparatus.

At least some embodiments aspects and embodiments of this disclosure are directed to a method for raising and lowering a pop-up camper, including: placing a pop-up camper adapter on an apparatus described above; inserting a pop-up camper raising bar into the pop-up camper adapter; inserting a powered electric drill into a drill slot through the apparatus; rotating the drill in one direction to raise a top of the pop-up camper; rotating the drill in an opposite direction to lower the top of the pop-up camper.

At least some embodiments aspects and embodiments of this disclosure are directed to a kit including: a) an apparatus for reducing rotational speed, including: an enclosed gear box; a gear speed reduction drive comprising a first gear and a second gear that is circumferentially smaller than the first gear and that either (a) directly drives the first gear in a direction opposite to a direction of the second gear, or (b) indirectly drives the first gear in the same direction as the direction of the second gear; the gear speed reduction drive being disposed within the enclosed gear box; the gear speed reduction drive being disposed within the enclosed gear box, the second gear being a sixty tooth sprocket and the first gear being an eleven tooth sprocket; an input shaft extending from the second gear, the drive shaft driving the gear speed reduction drive; an output shaft driven by the first gear and having an adapter end, the rotational speed of the output shaft being slower than the rotational speed; a chain between the first and second gears, and wherein the second gear indirectly drives the first gear through movement of the chain; b) a first adapter for connecting the apparatus for reducing rotational speed to a first brand of pop-up camper having a first mechanism for raising and lowering the pop-up camper; c) a second adapter for connecting the apparatus for reducing rotational speed to a second brand of pop-up camper having a second mechanism different from the first mechanism for raising and lowering the pop-up camper. In at least some embodiments, the apparatus can further include d) a third adapter for connecting the apparatus for reducing rotational speed to a vehicle jack for raising and lowering a vehicle in order to change a vehicle tire.

In at least some embodiments, the apparatus can further include a motor and a rechargeable battery for providing power to turn the input shaft. In at least some embodiments, the motor and the rechargeable battery are contained within the housing.

At least some embodiments aspects and embodiments of this disclosure are directed to a portable apparatus for reducing rotational speed, including: an enclosed gear box; a gear speed reduction drive including a first gear and a second gear that is circumferentially smaller than the first gear and that drives the first gear, the gear speed reduction drive being disposed within the enclosed gear box; an input shaft extending from the second gear, the drive shaft driving the gear speed reduction drive; an output shaft driven by the first gear and having an adapter end, the rotational speed of the output shaft being slower than the rotational speed; at least one removable adapter (or a plurality of removable adapters) attachable to the output shaft and that turns when the output shaft is turned.

Other exemplary embodiments and advantages of this disclosure can be ascertained by reviewing the present disclosure and the accompanying drawings.

### BRIEF DESCRIPTION OF THE SEVERAL VIEWS OF THE DRAWING(S)

This disclosure is further described in the detailed description that follows, with reference to the drawings, in which:

FIG. 1 shows a side view of a portable power system and apparatus in accordance with at least some aspects of this disclosure;

FIG. 2 shows an overhead view of a portion a pop-up camper and a portable power system and apparatus in accordance with at least some aspects of this disclosure;

FIG. 3A shows a side view of a portable power system and apparatus including a first gear that is directly driven by a second gear all in accordance with at least some aspects of this disclosure;

FIG. 3B shows a side view of a portable power system and apparatus including a first gear that is indirectly driven by a second gear all in accordance with at least some aspects of this disclosure;

FIG. 4A shows an overhead view of a portable power system and apparatus in accordance with at least some aspects of this disclosure;

FIG. 4B shows a side cross-section of an output shaft for the portable power system and apparatus of FIG. 4A in accordance with at least some aspects of this disclosure;

FIG. 4C shows a side cross-section of an input shaft for the portable power system and apparatus of FIG. 4A in accordance with at least some aspects of this disclosure;

FIG. 5A shows a side of an adapter for adapting a portable power system and apparatus to some types, brands, and/or models of pop-up trailers, all in accordance with at least some aspects of this disclosure; and

FIG. 5B shows a side of an adapter for adapting a portable power system and apparatus to other types, brands, and/or models of pop-up trailers, all in accordance with at least some aspects of this disclosure.

### DETAILED DESCRIPTION OF THE INVENTION

Exemplary embodiments of this disclosure are described herein by way of example.

The systems, methods, and apparatus of this disclosure are described with reference to the attached drawings.

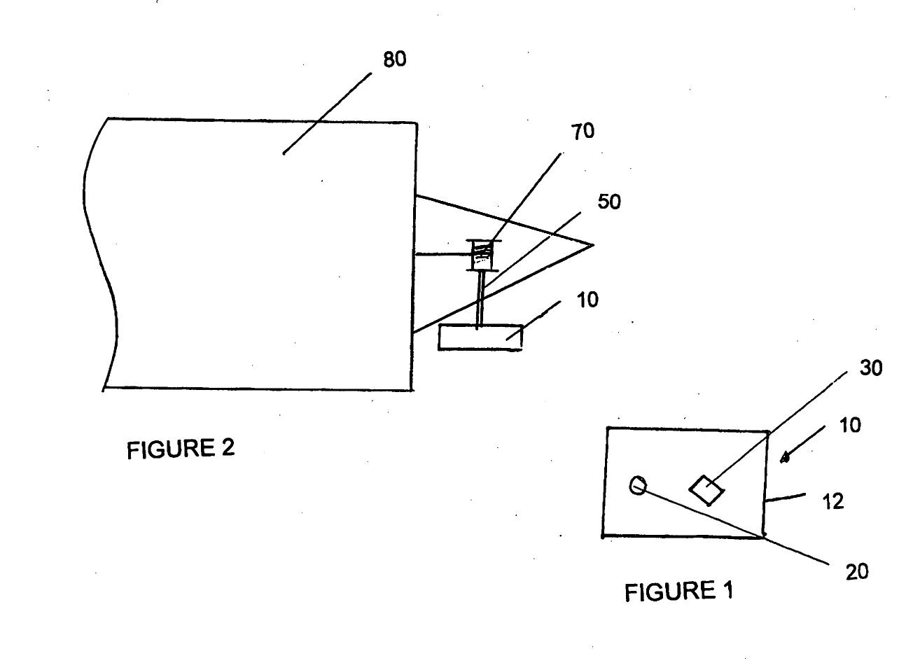

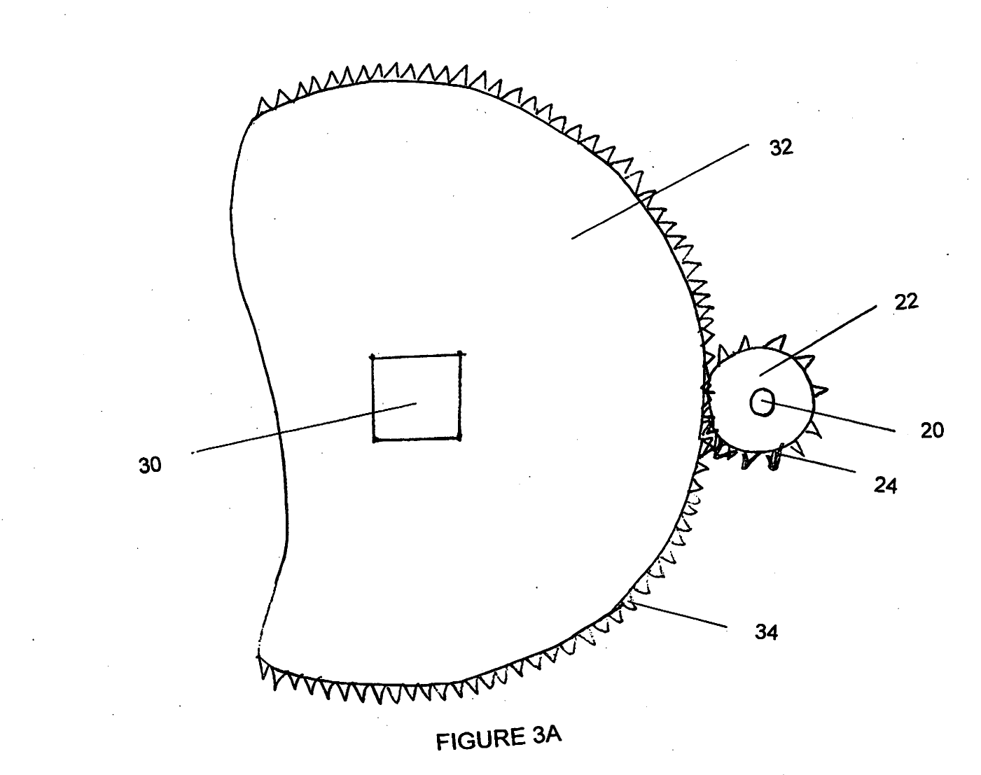

In at least some exemplary embodiments, this disclosure is directed to a gear reduction system and apparatus, such as apparatus 10 in FIG. 1 shown with an input shaft 20 and an output shaft 30. As shown in FIG. 2, the gear reduction apparatus 10 can be utilized with an adapter 50 that is compatible with a manual winch, such as manual winch 70 for a pop-up camper such as pop-up camper 80.

In accordance with the exemplary embodiments of this disclosure, the term “gear” as used herein may refer to a substantially annular or circular article of manufacture with or without teeth that can be utilized to drive another gear either directly by rotational contact between the two gears or indirectly by, for example, a belt or chain running around the two gears (like on a chain around the front and rear gears of a bicycle).

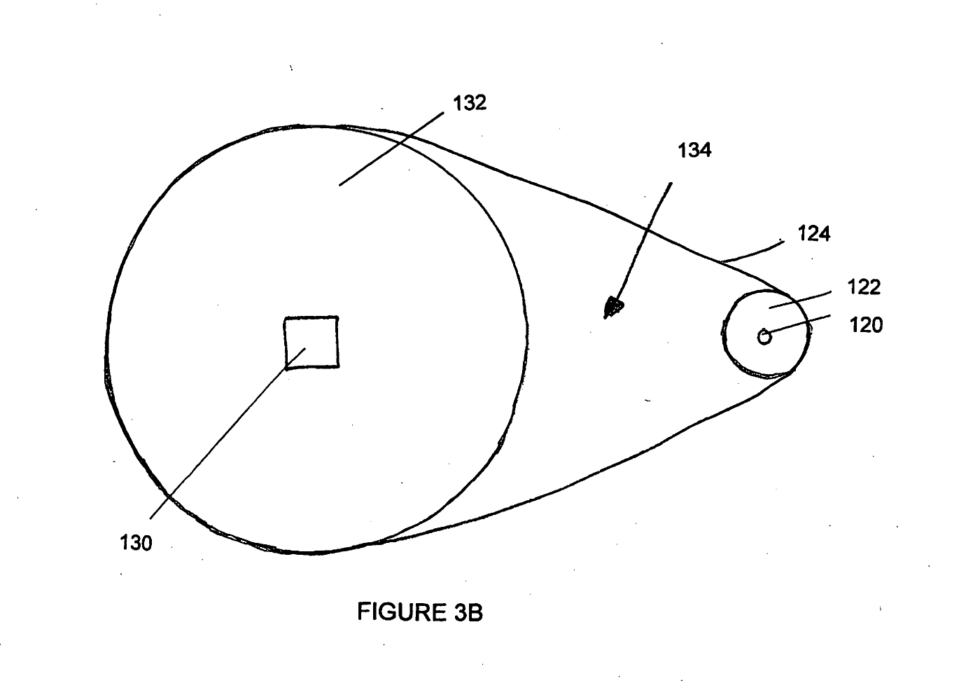

For example, as shown in FIG. 3A, the system and apparatus can include a gear reduction system utilizing two gears, including a larger diameter first gear 32, which can have teeth 34, connected to the output shaft 30 and a smaller diameter second gear 34, which can have teeth 24, connected to input shaft 20. The two gears 22 and 32 can be located within a housing, for example a plastic or metal housing 12 as shown FIG. 1.

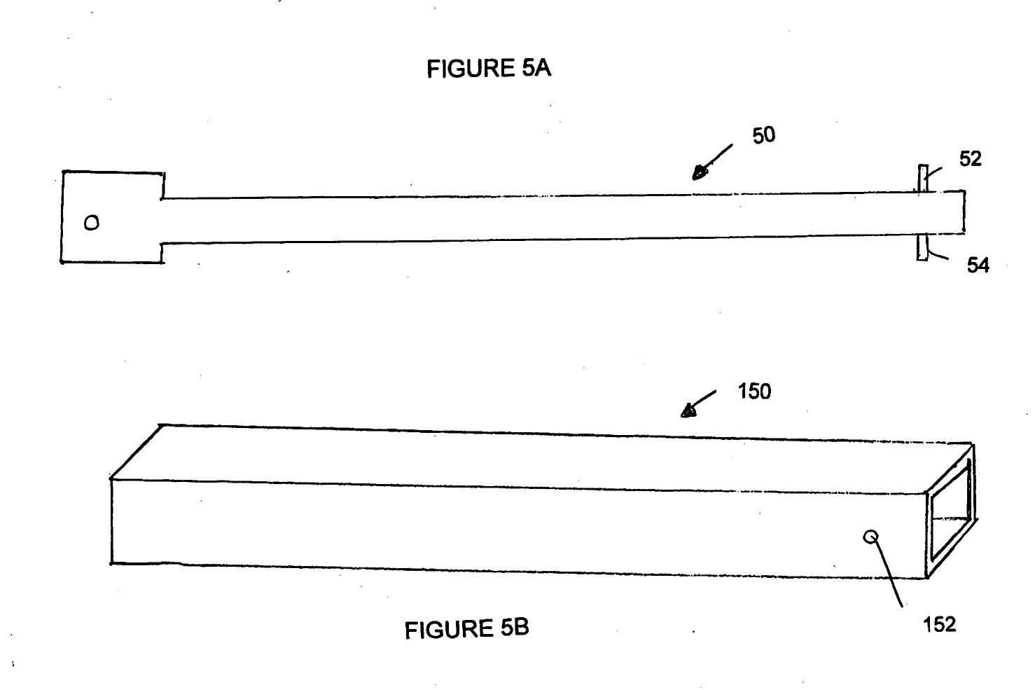

An adapter, such as adapters 50 and 150 shown in FIGS. 5A and 5B, respectively, can be utilized to removably connect or attach one gear (e.g., the larger gear) to an existing manual winch for, for example, a pop-up camper. The adapters can attach at one end to the output shaft 30 by any suitable manner, such as for example and cotter pin mechanism, by screwing the devices together, by mating latches, and the like. The adapters can attach at the other end to the manual winch also by any suitable manner, such as for example and cotter pin mechanism, by screwing the devices together, by mating latches, and the like. Adapter 50 in FIG. 5A is shown with pins 52 and 54 to engage with corresponding holes or slots (not shown) in one style of manual winch of a pop-up camper. Adapter 150 in FIG. 5B is shown with holes for engaging with a pin (not shown) in a different style of manual winch of a pop-up camper.

Those of skill in the art will recognize that many different adapters can be provided for many different applications, such as for example lifting mechanisms for eighteen wheel trailers, boat trailers, vehicles, as well as buffing tools for a vehicle, etc. Other possible applications are discussed later.

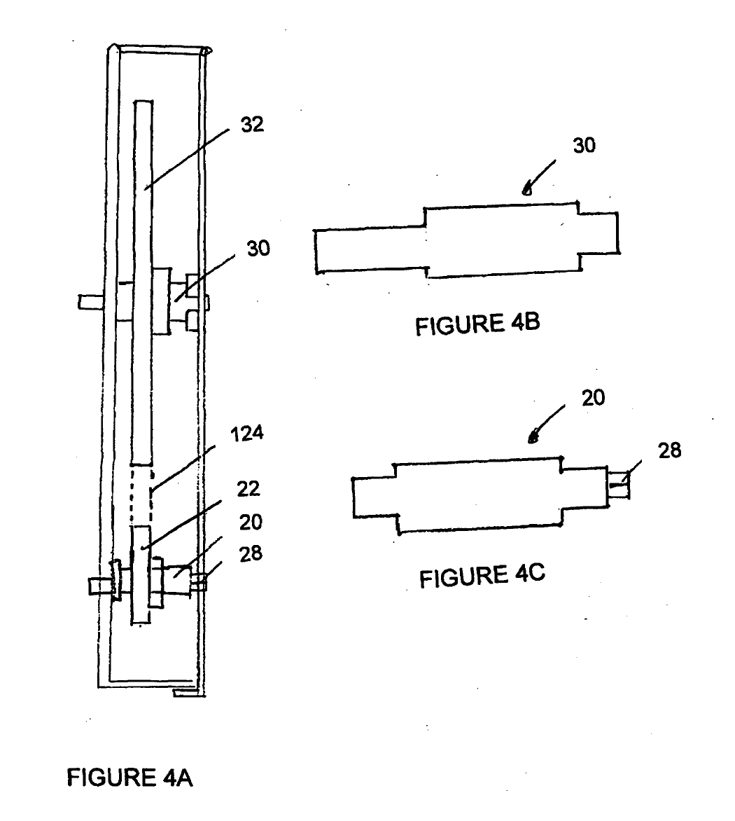

As shown in FIGS. 4A and 4C, a drill attachment, such as drill attachment 28 extending from the input shaft 20 can be employed so that a gear (e.g., the smaller gear 22) can be powered by a drill (not shown). The drill attachment 28 can be, for example, a quarter inch hex drill shank. In accordance with at least some embodiments of this disclosure, a drill (e.g., through the drill attachment) can be utilized to power the smaller gear 22, which powers the larger gear 32, which via the output shaft 30 and via an adapter, such as adapters 50 and 150 (FIGS. 5A and 5B) powers the manual winch 70 (FIG. 2) of the pop-up camper 80 (FIG. 2), thereby raising or lowering the pop-up camper 80. Any suitable manner can be utilized for removably attaching the drill to the input shaft. As shown, the input shaft has the attachment 28 that acts like a “bit” for the drill. Alternatively, a slot or the like could be provided and, for example, a screwdriver bit could be inserted in the slot or the like and utilized to turn the input shaft, and this the gears.

In another exemplary embodiment as illustrated in FIG. 3B, the system and apparatus can include a sprocket system utilizing a pair of sprockets including a first larger sprocket 132 connected to an output shaft 130 and a second smaller sprocket 122 connected to an input shaft 120. The two sprockets 122 and 132 can be located within a housing, for example a metal or plastic housing such as housing 12 in FIG. 1. A space 134 can be provided between the two sprockets 122 and 132. A chain (e.g., a bicycle type chain) or belt 124 can run between the two sprockets 122 and 132, so that moving one sprocket results in movement of the chain or belt 124, which moves the second sprocket. Similarly, the system and apparatus can include a pair of pulleys and a belt.

An adapter (or a set of different adapters such as adapters 50 and 150) can be provided, for example as part of a kit with the portable power system and/or apparatus, and can be utilized to removably connect or attach one sprocket to an existing manual winch for a pop-up camper. The adapter 50 of FIG. 5A includes pins 52 and 54 for connecting to particular trailers. For example, an adapter 50 having a half inch diameter round shaft and one inch pins 52 and 54 can be utilized to connect to a Fleetwood™ brand of pop-up trailer. An adapter 150 having pinholes 152 can be utilized to connect to Coachmen™, Viking™, Forest River™, Rockwood™, and Palomino™ brand pop-up campers.

For example, a drill attachment can be employed such that a sprocket can be powered by a drill. The drill attachment can be, for example, a quarter inch hex drill shank. Those of ordinary skill in the art will recognize that in accordance with an exemplary embodiment of this disclosure, the drill (e.g., through the drill attachment) can be utilized to power a first sprocket which, via a chain, powers the second sprocket, which via the adapter can power, for example, the manual winch of a pop-up camper, thereby raising or lowering the pop-up camper.

In accordance with exemplary embodiments of this disclosure, a person with a manual lift pop-up camper can easily insert the adapter into the existing handle receptacle for a manual winch. By attaching a portable battery powered reversible drill, a gear or sprocket system can be powered as described above. The gear or sprocket system can power turning of the adapter and, as a result, the pop-cup camper can be raised and lowered with ease.

Those of ordinary skill in the art will also recognize that in addition to the exemplary embodiments described above, a variety of configurations can be employed wherein a battery powered drill can be utilized to power the adapter described herein, so that a pop-up camper can be raised and lowered with ease. For example, in another exemplary embodiment, the system and apparatus of this disclosure can include a pulley system including a pair of pulleys, with a belt running between the two pulleys. In such an exemplary embodiment, the movement of one pulley results in movement of the belt which results in movement of the second pulley. Those of ordinary skill in the art will recognize a variety of additional configurations that are within the scope of this disclosure.

Thus, in view of the exemplary embodiments described above, the systems, methods, and apparatus of this disclosure provide a solution that can be not only easy to use, but cost effective.

Those of ordinary skill in the art will recognize that the systems, methods, and apparatus of this disclosure can have a variety of additional applications. For example, the systems and apparatus of this disclosure can be attached to a small winch and utilized to assist in loading and unloading boats, and loading and unloading small trailers with items such as lawn mowers and possibly small autos.

In another example, in conjunction with a block and tackle or a pole and pulley, systems, methods, and apparatus of this disclosure can be utilized to lift and lower heavy items such as construction material from one floor to another floor (e.g., from a lower floor to a higher floor). In another, example, the systems, methods, and apparatus of this disclosure can include an adapter configured for utilization with a car jack, for example a jack for raising and lowering a car when changing a tire. In another example, the systems, methods, and apparatus of this disclosure can be utilized to assist in raising and lowering the landing gear on semi-trailers. Furthermore, those of ordinary skill in the art will recognize that the systems, methods, and apparatus of this disclosure can be configured as a stand-alone device or as part of (e.g., integrated with) an apparatus (e.g., a winch, car/tire jack) that raises and lowers an item such as a trailer, boat, car, construction pallet, and so on.

In the camping world, there are a great number of retired and elderly people who have difficulty operating manual devices, i.e. manual jacks, slides, and especially lift systems on pop-up campers. The systems, methods, and apparatus of this disclosure can address all of these problems.

In addition to the above, the systems, methods, and apparatus of this disclosure can be utilized for raising and lowering the manual jacks to level nearly all camping trailers. Also many of the higher end units have slide outs and electric jacks, such as are on the front of nearly all 5^{th} wheel Trailers. Occasions arise when either because of a weak battery or a malfunction, they have to be operated manually. This can be difficult to impossible for some people. The systems, methods, and apparatus of this disclosure can readily accomplish these tasks with ease.

Another application of the apparatus and systems of this disclosure is to enable a camper owner to maneuver his/her pop-up or small travel trailer around the yard, driveway or campsite with ease, and without a tow vehicle, saving time and fuel. The systems and apparatus of this disclosure can make it easy to hook up to a tow vehicle without help and without making several attempts. At a campsite, systems and apparatus of this disclosure can allow the owner to park and set up their camper, again with ease.

In at least some embodiments, the systems and apparatus of this disclosure can work with a portable battery operated drill. In at least some embodiments, the systems and apparatus of this disclosure can incorporate a high impact body with a built in power system utilizing a rechargeable battery, making for a light and very user friendly product.

In at least some embodiments, the systems and apparatus of this disclosure can also aid in making work easier and saving valuable time for tractor-trailers to, for example, on empty and loaded trailers, raise and lower the landing gear, jack system, that has been traditionally done by hand. With the addition of a buffer wheel, the systems and apparatus of this disclosure can enable the drivers to clean, wax and buff their tractors and trailers which can make it more desirable to the driver and their company.

In at least some embodiments, the systems and apparatus of this disclosure can also be utilized in the boat industry to, for example, attach to an existing boat trailer winch, making the grueling task of loading the boat so easy. Other boat applications can, for example, include: power anchor systems, emergency bilge pumps, and emergency power drives.

The portable power system and apparatus of this disclosure can, in some embodiments be utilized with a rechargeable battery or batteries for many different applications. For example, the portable power system and apparatus of this disclosure can, in some embodiments be utilized with a rechargeable battery or batteries with or as part of an auto and truck jacks i.e. scissor type.

As another example, the portable power system and apparatus of this disclosure can, in some embodiments be utilized with a rechargeable battery or batteries with or as part of a portable winch and cable can be utilized to aide in pulling incapacitated vehicles by moving them, or loading them on trailers.

As another example, the portable power system and apparatus of this disclosure can, in some embodiments be utilized with a rechargeable battery or batteries with or as part of an auger where mobile home augers are utilized to screw anchors in the ground.

As another example, the portable power system and apparatus of this disclosure can, in some embodiments be utilized with a rechargeable battery or batteries with or as part of a portable crane system utilized for loading, lifting items onto trucks or on construction sites to lift items between floors.

As another example, the portable power system and apparatus of this disclosure can, in some embodiments be utilized with a rechargeable battery or batteries to raise and lower overhead doors.

As another example, the portable power system and apparatus of this disclosure can, in some embodiments be utilized with a rechargeable battery or batteries with or as part of to install and tighten fencing.

As another example, the portable power system and apparatus of this disclosure can, in some embodiments be utilized with a rechargeable battery or batteries with or as part of a portable platform, engine, or motorcycle lift system.

As another example, the portable power system and apparatus of this disclosure can, in some embodiments be utilized with a rechargeable battery or batteries with or as part of a children's riding toy such as cars and motorcycles. Similarly, the portable power system and apparatus of this disclosure can, in some embodiments be utilized with a rechargeable battery or batteries to assist in powering bicycles and scooter platforms.

As another example, the portable power system and apparatus of this disclosure can, in some embodiments be utilized with a rechargeable battery or batteries to easily raise and lower awnings.

The portable power system and apparatus of this disclosure can, in some embodiments be utilized with a stationary battery or electric drive in order to provide rotational drive to the following types of applications: auto and truck lift systems, cement mixers, concrete finishers, buffers, mowers, weed eaters, aerators, tillers, chain saws, liquid pumps, air compressors, hydraulic pumps, tile cutters, vacuums, impact wrenches, trenchers, underground pipe pullers, stump grinders and other applications.

The portable power system and apparatus of this disclosure can, in some embodiments be utilized with power wood shop tools, such as lathes, power saws, edger routers, planers, sanders, jointers, drill presses, band saws, grinders, and other shop tools.

It will be recognized that a variety of power sources may be utilized with the portable power system and apparatus of this disclosure, for example an 8 to 36 volt portable battery and a 12 to 24 volt non-portable battery and electric power source.

Many of the above devices can be utilized in rental services. The portable power systems and apparatus of this disclosure can be operated with the above mentioned items utilizing quality components and adapters to make a user friendly, low cost system.

The portable power system and apparatus of this disclosure can include a variety of gear types, sizes and configurations, such as for example a 5.45 to 1 ratio with a 60 tooth sprocket and an 11 tooth sprocket and a number 35 chain. Furthermore, a 2 to 1 to 20 to 1 ratio can be utilized, for example with a sprocket and chain mechanism or a gear to gear mechanism.

As mentioned above, the term “gear” as used herein refers to a substantially annular or circular article of manufacture with or without teeth that can be utilized to drive another gear either directly by rotational contact between the two gears or indirectly by, for example, a belt or chain running around the two gears.

In at least some embodiments, an adapter, which can be a sleeve about 1″ square on one end can slide into a winch receptacle on the other end. Other adapters having different shaped and sized ends, for example a round end, can also be included as part of kit with the portable power system and apparatus of this disclosure. Thus, adapters for many different applications can be included, for example, as part of a kit. As mentioned above, the adapters can attach at one end to the output shaft 30 by any suitable manner, such as for example and cotter pin mechanism, by screwing the devices together, by mating latches, and the like. The adapters can attach at the other end to the manual winch also by any suitable manner, such as for example utilizing a cotter pin mechanism, by screwing the devices together, by mating latches, and the like. In at least some embodiments of this disclosure, the systems, methods, and apparatus do not utilize a ring and pinion gear system.

In at least some embodiments of this disclosure, the gear ratio can be, for example, 5.4 to 1

In at least some embodiments of this disclosure, the systems, methods, and apparatus, the unit is not permanently mounted to become part of the pop-up camper by replacing the camper winch drum, but instead is a hand held unit readily adaptable to most pop-up campers utilizing an easy quick connect slide adapter that can be installed in seconds making the unit ready to utilize on many different brands and sizes of pop-up campers.

In at least some embodiments of this disclosure, the systems, methods, and apparatus do not require a heavy twelve volt motor and winch with a twelve volt automotive type battery, but is instead totally portable utilizing, for example, a hand held battery drill.

In at least some, the unit allows the owner to raise and lower the unit by hand either utilizing the original hand crank or a crank on our unit allowing the owner to utilize the, for example 5.4 to 1, gear ratio making it much easier to raise his pop-up camper. Thus, it can be very simple to raise and lower the pop-up camper if there is a problem such as a dead battery.

The electric lift system and apparatus of this disclosure provides numerous advantages. First, it is simple to install, in particular because it does not require a user to remove the manual system. Second, since the system and apparatus is easy to remove, the manual system is always easily available for use. Thus, if the battery goes dead on the electric lift system, a user can always easily utilize the manual system to raise or lower their pop-up camper. Third, the electric lift system of this disclosure is relatively inexpensive.

The foregoing exemplary embodiments have been provided for the purpose of explanation and are in no way to be construed as limiting this disclosure. This disclosure is not limited to the particulars disclosed herein, but extends to all embodiments within the scope of the appended claims, and any equivalents thereof.

1. A portable apparatus for reducing rotational speed, comprising:
an enclosed gear box;
a gear speed reduction drive comprising a first gear and a second gear that is circumferentially smaller than the first gear and that either (a) directly drives the first gear in a direction opposite to a direction of the second gear, or (b) indirectly drives the first gear in the same direction as the direction of the second gear; the gear speed reduction drive being disposed within the enclosed gear box;
an input shaft extending from the second gear, the drive shaft driving the gear speed reduction drive;
an output shaft driven by the first gear and having an adapter end, the rotational speed of the output shaft being slower than the rotational speed.

2. The apparatus of claim 1, further comprising a connector having an end configured to engage with the adapter end and an opposite end configured to connect to a pop-up camper for raising and lowering the pop-up camper.

3. The apparatus of claim 1, further comprising a connector having an end configured to engage with the adapter end and an opposite end configured to connect to a vehicle jack for raising and lowering a vehicle or vehicle trailer.

4. The apparatus of claim 1, further comprising a first removable connector having an end configured to engage with the adapter end and an opposite end configured to connect to a vehicle jack for raising and lowering a vehicle or vehicle trailer and a second removable connector having an end configured to engage with the adapter end and an opposite end configured to connect to a pop-up camper for raising and lowering the pop-up camper.

5. The apparatus of claim 1, further comprising a first removable connector having an end configured to engage with the adapter end and an opposite end configured to a first pop-up camper having a particular connecting mechanism for raising and lowering the pop-up camper and a second removable connector having an end configured to engage with the adapter end and an opposite end configured to connect to a second pop-up camper having a different connecting mechanism from the first for raising and lowering the pop-up camper.

6. The apparatus of claim 1, wherein the circumferential ratio of the second gear to the first gear ranges from a ratio of 2 to 1 to a ratio of 20 to 1.

7. The apparatus of claim 6, wherein the circumferential ratio is 5.45 to 1.

8. The apparatus of claim 6, wherein the second gear is a 60 tooth sprocket and the first gear is an 11 tooth sprocket.

9. The apparatus of claim 8, further comprising a chain between the first and second gears, and wherein the second gear indirectly drives the first gear through movement of the chain.

10. The apparatus of claim 9, wherein the chain is a number 35 chain.

11. The apparatus of claim 1, further comprising a belt between the first and second gears, and wherein the second gear indirectly drives the first gear through movement of the belt.

12. The apparatus of claim 8, wherein the second gear directly contacts and drives the first gear.

13. The apparatus of claim 1, further comprising a motor and a rechargeable battery contained within the housing to provide power to turn the input shaft.

14. The apparatus of claim 1, wherein the input shaft can be turned by a rotary power tool that is separate from the apparatus.

15. A method for raising and lowering a pop-up camper, comprising:
removably connecting a pop-up camper adapter to the apparatus of claim 2;
removing connecting a pop-up camper raising bar to the pop-up camper adapter;
removably connecting a powered electric drill to the apparatus;
rotating the drill in one direction to raise a top of the pop-up camper or rotating the drill in an opposite direction to lower the top of the pop-up camper;
removing the powered drill from the apparatus;
removing the adapter from the raising bar; and
removing the adapter from the apparatus.

16. A kit comprising:
a) an apparatus for reducing rotational speed, comprising:
an enclosed gear box;
a gear speed reduction drive comprising a first gear and a second gear that is circumferentially smaller than the first gear and that either indirectly drives the first gear in the same direction as the direction of the second gear; the gear speed reduction drive being disposed within the enclosed gear box;
an input shaft extending from the second gear, the drive shaft driving the gear speed reduction drive;
an output shaft driven by the first gear and having an adapter end, the rotational speed of the output shaft being slower than the rotational speed;
a chain between the first and second gears, and wherein the second gear indirectly drives the first gear through movement of the chain;
b) a first adapter for connecting the apparatus for reducing rotational speed to a first pop-up camper having a first mechanism for raising and lowering the pop-up camper;
c) a second adapter for connecting the apparatus for reducing rotational speed to a second pop-up camper having a second mechanism different from the first mechanism for raising and lowering the pop-up camper.

17. The kit of claim 16 further comprising a motor and a rechargeable battery for providing power to turn the input shaft.

18. The kit of claim 19, wherein the motor and the rechargeable battery are contained within the housing.

19. The kit of claim 16, further comprising d) a third adapter for connecting the apparatus for reducing rotational speed to a vehicle jack for raising and lowering a vehicle or vehicle trailer.

20. A portable apparatus for reducing rotational speed, comprising:
an enclosed gear box;
a gear speed reduction drive comprising a first gear and a second gear that is circumferentially smaller than the first gear and that drives the first gear, the gear speed reduction drive being disposed within the enclosed gear box;
an input shaft extending from the second gear, the drive shaft driving the gear speed reduction drive;
an output shaft driven by the first gear and having an adapter end, the rotational speed of the output shaft being slower than the rotational speed;
at least one removable adapter attachable to the output shaft and that turns when the output shaft is turned.
